(19) United States
(12) Patent Application Publication
(10) Pub. No.: US 2026/0175374 A1
(43) Pub. Date: Jun. 25, 2026

(54) ANGLED TOOL CONNECTING DEVICE

(71) Applicant: SHIN YING ENTPR CO., LTD., Taichung City (TW)

(72) Inventor: WEN-HUNG CHIANG, Taichung City (TW)

(21) Appl. No.: 18/987,377

(22) Filed: Dec. 19, 2024

(51) Int. Cl. B25B 23/00; B25B 23/12

(52) U.S. Cl. CPC B25B 23/0035; B25B 23/12

(57) ABSTRACT

An angled tool connecting device is provided, wherein the angled tool connecting device includes: a housing including a body portion and a head portion transversely connected to each other; a shaft rotatably inserted in the body portion and including a first end portion configured to be connected to a first tool, and a second end portion; and a socket assembly including a driving sleeve rotatably inserted in the head portion and rotatably connected to the second end portion, and an outer sleeve detachably sleeved on the driving sleeve, the driving sleeve being configured to be connected to a second tool, the outer sleeve including a first magnetic member located on a side remote from the driving sleeve, the driving sleeve including a magnetic component, the magnetic component being embedded in the head portion and protrusive beyond an inner surface of the head portion.

### BACKGROUND OF THE INVENTION

### Field of the Invention

The present invention relates to a driving tool, particularly to an angled tool connecting device.

### Description of the Prior Art

In many fields, such as the assembly, disassembly, connection, or fastening of devices or mechanisms, it is often necessary to use driving tools (e.g., electric, pneumatic, or manual tools) to drive driving components (e.g., screwdriver bits, drill bits, or tool adapters) to rotate, thereby connecting fasteners or connectors to devices or mechanisms.

In certain situations, such as when the orientation of the driving connector or fastener is not perpendicular to the device or mechanism, or when the position of the connector or fastener is located in a narrow space, general straight-type driving tools cannot effectively output power at an angle, resulting in unsuccessful operations. Consequently, universal joints or tool extension rods are conventionally used with driving tools to address these operational challenges. However, the conventional universal joints or tool extension rods, although capable of offering usage at various angles or extensions, still pose inconvenience in the retention and separation between the driving components and connection structures.

The present invention is, therefore, arisen to obviate or at least mitigate the above-mentioned disadvantages.

### SUMMARY OF THE INVENTION

The main object of the present invention is to provide an angled tool connecting device which is capable of outputting power at an angle and facilitating the removal of driving tools.

To achieve the above and other objects, an angled tool connecting device is provided, wherein the angled tool connecting device includes: a housing including a body portion and a head portion transversely connected to the body portion; a shaft rotatably inserted in the body portion and including a first end portion and a second end portion opposite to the first end portion, the first end portion being configured to be connected to a first tool; and a socket assembly including a driving sleeve rotatably inserted in the head portion, and an outer sleeve detachably sleeved on the driving sleeve, the driving sleeve being rotatably connected to the second end portion, the driving sleeve being configured to be connected to a second tool, the outer sleeve including a first magnetic member located on a side remote from the driving sleeve, the driving sleeve including a magnetic component arranged on an end thereof, the magnetic component being embedded in the head portion and protrusive beyond an inner surface of the head portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is a partial enlarged view of FIG. 2;

FIG. 4 is a cross-sectional view of an exemplary embodiment of the present invention;

FIG. 5 is a partial enlarged view of FIG. 4; and

FIG. 6 is a drawing showing an application of an exemplary embodiment of the present invention.

### DETAILED DESCRIPTION OF THE PREFERRED EMBODIMENTS

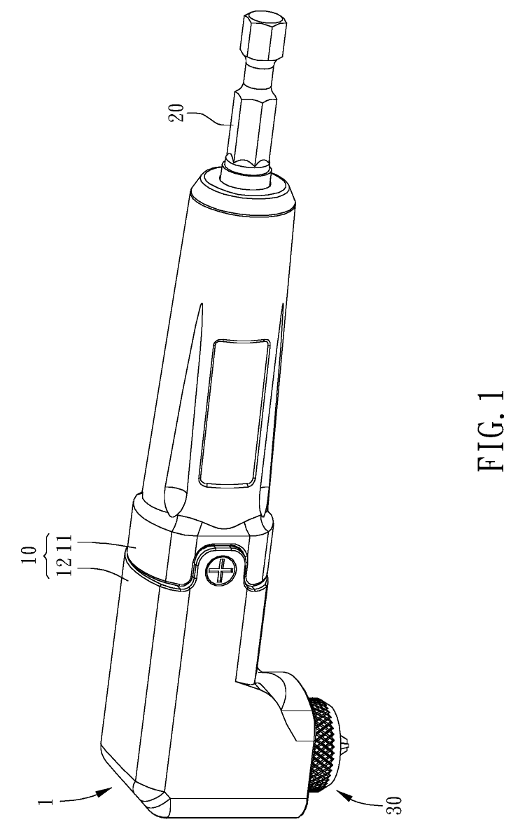

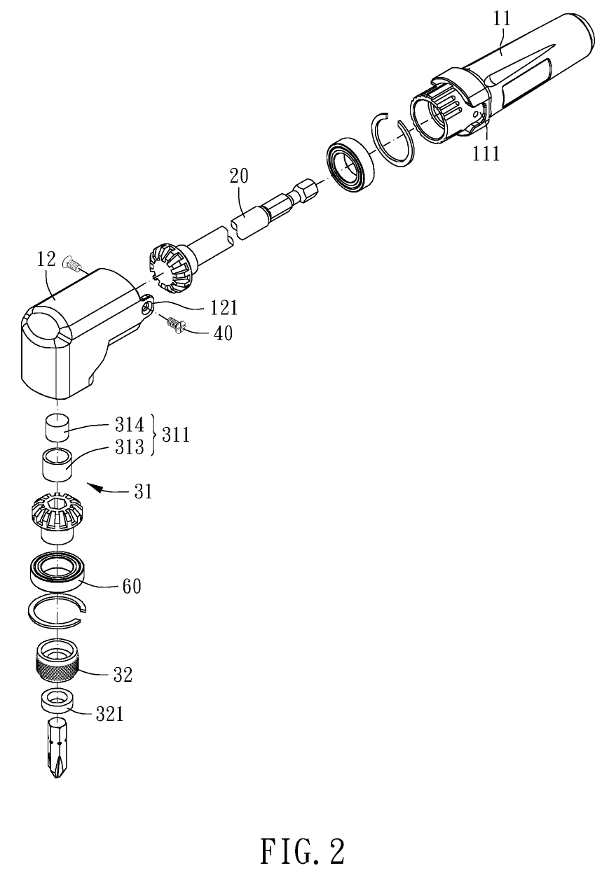

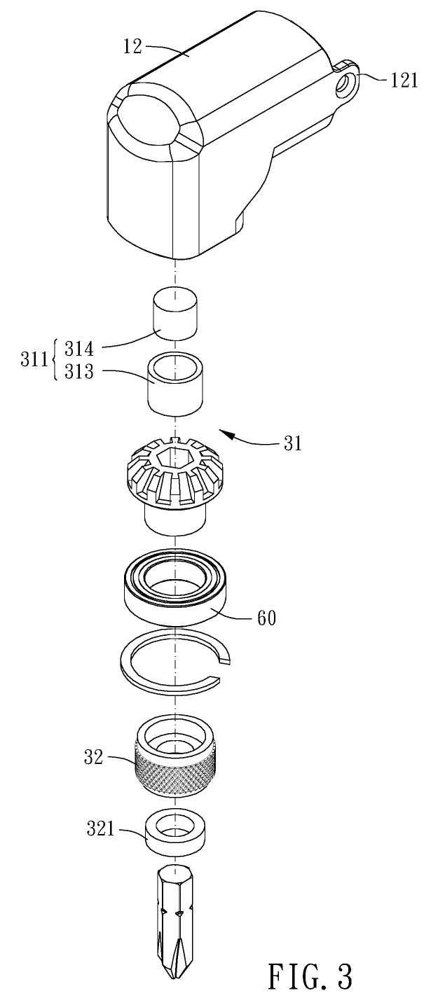

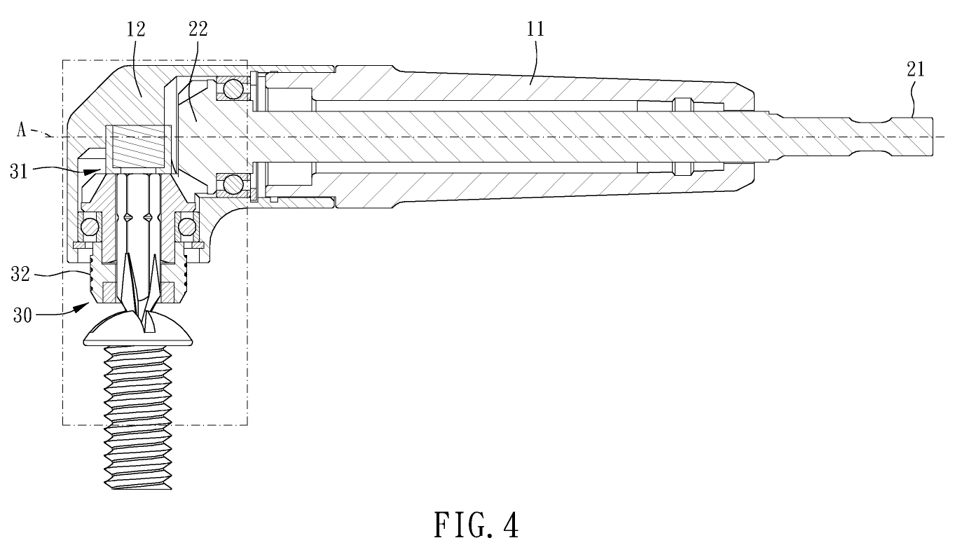

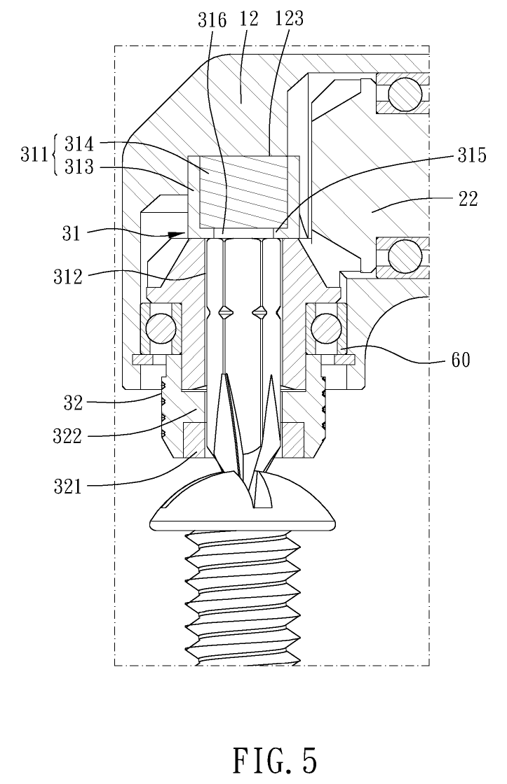

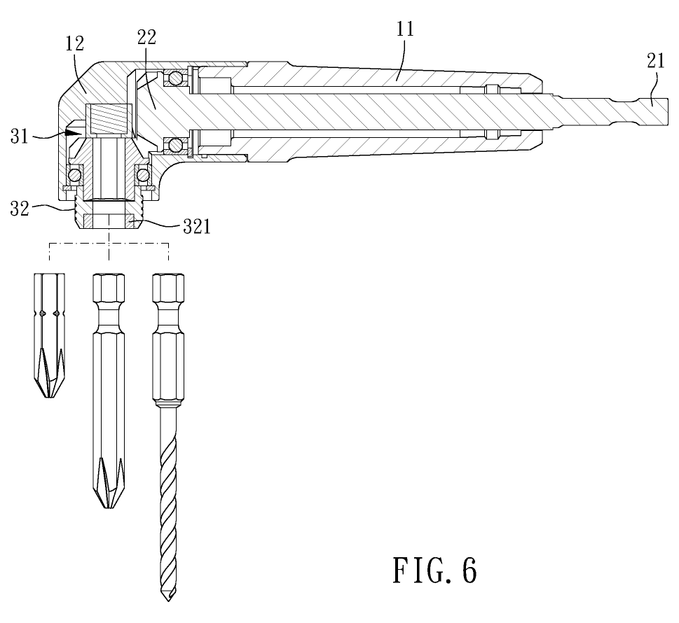

Please refer to FIGS. 1 to 6 for an exemplary embodiment of the present invention. An angled tool connecting device 1 of the present invention includes a housing 10, a shaft 20, and a socket assembly 30.

The housing 10 includes a body portion 11 and a head portion 12 transversely (e.g., but not limited to perpendicularly) connected to the body portion 11. The shaft 20 is rotatably inserted in the body portion 11 and includes a first end portion 21 and a second end portion 22 opposite to the first end portion 21. The first end portion 21 is configured to be connected to a first tool (e.g., electric, pneumatic, or manual tool). The socket assembly 30 includes a driving sleeve 31 rotatably inserted in the head portion 12, and an outer sleeve 32 detachably sleeved on the driving sleeve 31. The driving sleeve 31 is rotatably connected to the second end portion 22 and configured to be connected to a second tool (e.g., screwdriver bits, drill bits, or tool adapters). The outer sleeve 32 is located on a side remote from the driving sleeve 31 and includes a first magnetic member 321. The driving sleeve 31 includes a magnetic component 311 arranged on an end thereof. The magnetic component 311 is embedded in the head portion 12 and protrudes beyond an inner surface of the head portion 12. Accordingly, theion of the body portion 11 and the head portion 12 which are transversely connected each other allow power to be output at an angle, and the detachable outer sleeve 32 enables easy removal of the second tool inserted in the driving sleeve 31.

In this embodiment, the housing 10 is a rigid plastic member, which is easy to manufacture and can be molded into various structural forms. With the required structural strength, it provides a lightweight effect. However, the housing 10 may be made of other suitable materials. The outer circumferential wall of the body portion 11 includes at least one slot 111. The head portion 12 includes at least one ear portion 121, and the at least one ear portion 121 is inserted in the at least one slot 111. At least one fastener 40 is disposed through the at least one ear portion 121 and is connected to the body portion 11. Specifically, the outer circumferential wall of the body portion 11 includes two slots 111 diametrically arranged. The head portion 12 includes two ear portions 121 which are respectively inserted in the two slots 111. Two fasteners 40 are respectively disposed through the two ear portions 121 and are connected to the body portion 11, facilitating the alignment, assembly strength, and stability of the body portion 11 and the head portion 12 while enabling convenient and quick assembly, disassembly and maintenance.

Preferably, the driving sleeve 31 is a magnetically attractive member. Through the magnetic force of the first magnetic member 321, the outer sleeve 32 can be magnetically positioned with the driving sleeve 31. A radial flange 322 projects from the inner surface of the outer sleeve 32 and axially faces one end surface of the driving sleeve 31. The driving sleeve 31 and the first magnetic member 321 are located on opposite sides of the radial flange 322. The first magnetic member 321 is relatively closer to a distal end of the second tool so that it imparts magnetic force to the second tool, thereby more stably retaining the component (e.g., metallic screws) to be driven.

The angled tool connecting device 1 further includes a bearing 60 which is disposed in the head portion 12 and sleeved on the driving sleeve 31. Preferably, the outer sleeve 32 is a magnetic-conductive component, and the bearing 60 and the outer sleeve 32 are axially in contact. The radial flange 322 is axially spaced apart from the driving sleeve 31. Consequently, the magnetic attraction force between the outer sleeve 32 and the driving sleeve 31 is appropriate without being excessive. The outer sleeve 32 can thus be stably retained and conveniently detached.

The head portion 12 further includes a mounting hole 123, and the magnetic component 311 is received within the mounting hole 123 and protrudes beyond the mounting hole 123. The driving sleeve 31 includes an axial perforation 312, and the magnetic component 311 covers one end of the axial perforation 312.

In this embodiment, the shaft 20 defines an axial direction A. Preferably, the axial direction A extends through the driving sleeve 31. As such, the driving sleeve 31 can be more effectively retained between the second end portion 22 of the shaft 20 and the inner wall of the head portion 12. The driving sleeve 31 is less prone to deflection, rotates stably, and provides improved power transmission and output performance.

Specifically, the magnetic component 311 includes a shell member 313 embedded within the mounting hole 123 and a second magnetic member 314 received in the shell member 313. The shell member 313 includes a radial inner flange 315. The radial inner flange 315 is located between the second magnetic member 314 and the axial perforation 312, and the second magnetic member 314 is distanced from the second tool. The radial inner flange 315 defines a through hole 316 which is in communication with the axial perforation 312. This configuration shortens the axial dimension of the head portion 12 of the housing 10. Additionally, the magnetic component 311 can further magnetically attract and retain the second tool inserted in the driving sleeve 31, thereby more stably holding the second tool.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An angled tool connecting device including:
a housing including a body portion and a head portion transversely connected to the body portion;
a shaft rotatably inserted in the body portion and including a first end portion and a second end portion opposite to the first end portion, the first end portion being configured to be connected to a first tool; and
a socket assembly including a driving sleeve rotatably inserted in the head portion, and an outer sleeve detachably sleeved on the driving sleeve, the driving sleeve being rotatably connected to the second end portion, the driving sleeve being configured to be connected to a second tool, the outer sleeve including a first magnetic member located on a side remote from the driving sleeve, the driving sleeve including a magnetic component arranged on an end thereof, the magnetic component being embedded in the head portion and protrusive beyond an inner surface of the head portion.

2. The angled tool connecting device of claim 1, wherein the housing is a rigid plastic member.

3. The angled tool connecting device of claim 1, wherein the driving sleeve is a magnetically attractive member, a radial flange projects from an inner surface of the outer sleeve, the radial flange axially faces one end surface of the driving sleeve, and the driving sleeve and the first magnetic member are located on opposite sides of the radial flange.

4. The angled tool connecting device of claim 3, wherein further including a bearing, wherein the bearing is disposed in the head portion and sleeved on the driving sleeve, the bearing and the outer sleeve are axially in contact, the outer sleeve is a magnetic-conductive component, and the radial flange is axially spaced apart from the driving sleeve.

5. The angled tool connecting device of claim 1, wherein an outer circumferential wall of the body portion includes at least one slot, the head portion includes at least one ear portion, the at least one ear portion is inserted in the at least one slot, and at least one fastener is disposed through the at least one ear portion and connected to the body portion.

6. The angled tool connecting device of claim 1, wherein the head portion includes a mounting hole, the magnetic component is received within the mounting hole and protrusive beyond the mounting hole, the driving sleeve includes an axial perforation, and the magnetic component covers one end of the axial perforation.

7. The angled tool connecting device of claim 6, wherein the magnetic component includes a shell member embedded within the mounting hole and a second magnetic member received in the shell member, the shell member includes a radial inner flange located between the second magnetic member and the axial perforation, and the second magnetic member is distanced from the second tool.

8. The angled tool connecting device of claim 1, wherein the radial inner flange defines a through hole, and the through hole is in communication with the axial perforation.

9. The angled tool connecting device of claim 4, wherein the housing is a rigid plastic member; an outer circumferential wall of the body portion includes two slots diametrically arranged; the head portion includes two ear portions, the two ear portions are respectively inserted in the two slots, and two fasteners are respectively disposecd through the two ear portions and connected to the body portion; the head portion includes a mounting hole, the magnetic component is received within the mounting hole and protrusive beyond the mounting hole, the driving sleeve includes an axial perforation, and the magnetic component covers one end of the axial perforation; the magnetic component includes a shell member embedded within the mounting hole and a second magnetic member received in the shell member, the shell member includes a radial inner flange located between the second magnetic member and the axial perforation, and the second magnetic member is distanced from the second tool; the radial inner flange defines a through hole, and the through hole is in communication with the axial perforation.

10. The angled tool connecting device of claim 1, wherein the shaft defines an axial direction extending through the driving sleeve.
